(19) United States
(12) Patent Application Publication
(10) Pub. No.: US 2024/0356149 A1
(43) Pub. Date: Oct. 24, 2024

(54) BATTERY INCLUDING A COMPOSITE ENCLOSURE

(71) Applicant: GM Global Technology Operations LLC, Detroit, MI (US)

(72) Inventor: Seung-Woo Chu, Clawson, MI (US)

(73) Assignee: GM GLOBAL TECHNOLOGY OPERATIONS LLC, Detroit, MI (US)

(21) Appl. No.: 18/303,860

(22) Filed: Apr. 20, 2023

(51) Int. Cl. H01M 50/342; H01M 10/42; H01M 50/119; H01M 50/209; H01M 50/227; H01M 50/231

(52) U.S. Cl. CPC H01M 50/3425; H01M 10/4235; H01M 50/119; H01M 50/209; H01M 50/227; H01M 50/231

(57) ABSTRACT

A battery including a composite enclosure is provided. The battery includes a metal cell can enclosure including a plurality of faces. One of the plurality of faces is configured for locally failing during a thermal runaway event. The battery further includes a multilayer polymeric laminated film and a battery cell including a pair of electrodes including an anode and a cathode, a separator, and an electrolyte. The battery cell is hermetically sealed within the multilayer polymeric laminated film. The multilayer polymeric laminated film is contained within the metal cell can enclosure.

### BACKGROUND

The present disclosure related to a battery including a composite enclosure.

Lithium-ion batteries are desirable candidates for powering electronic devices in the consumer, automotive, naval, marine, and aerospace industries due to their relatively high energy density, high power density, lack of memory effect, and long cycle life, as compared to other rechargeable battery technologies, including lead-acid batteries, nickel-cadmium and nickel-metal-hydride batteries. The widespread commercialization of lithium batteries, however, is dependent upon their ensured performance under normal operating conditions, in the event of manufacturing defects, upon aging, as well as under a variety of abuse conditions, including exposure to high temperatures, overcharge, over-discharge, and exposure to external forces that physically damage one or more internal components thereof. Conditions that affect the thermal, chemical, electrical, and/or physical stability of lithium batteries may increase the internal temperature of such batteries, which may, in turn, set-off additional undesirable events and/or chemical reactions within the batteries that may lead to additional heat generation.

Battery cells are produced in different configurations. Pouch battery cells may be flat, thin battery cells encased in a flexible laminated aluminum pouch and may be useful to stack a plurality of the pouch battery cells in a relatively small package space. Metal can battery cells may be encased in a rigid, protective case. Examples of metal can battery cells may include examples of prismatic battery cells, which may include a rectangular outer case.

### SUMMARY

A battery including a composite enclosure is provided. The battery includes a metal cell can enclosure including a plurality of faces. One of the plurality of faces is configured for locally failing during a thermal runaway event. The battery further includes a multilayer polymeric laminated film and a battery cell including a pair of electrodes including an anode and a cathode, a separator, and an electrolyte. The battery cell is hermetically sealed within the multilayer polymeric laminated film. The multilayer polymeric laminated film is hermetically sealed within the metal cell can enclosure.

In some embodiments, the battery further includes a plurality of battery cells.

In some embodiments, the battery further includes a plurality of multilayer polymeric laminated films. Each of the plurality of battery cells is hermetically sealed within one of the plurality of multilayer polymeric laminated films. The plurality of multilayer polymeric laminated films is hermetically sealed within the metal cell can enclosure.

In some embodiments, the plurality of battery cells is hermetically sealed within the multilayer polymeric laminated film.

In some embodiments, the one of the plurality of faces is constructed with a first metal with a relatively low melting point. A second of the plurality of faces is constructed with a second metal with a relatively high melting point.

In some embodiments, the metal cell can enclosure includes a plurality of faces. One of the plurality of faces is configured as a sacrificial face including a two-stage vent. The two-stage vent includes a first stage including a notch, a thin portion, or a weakened portion configured for initially failing at an outset of a thermal runaway event. The two-stage vent further includes a second stage including a remainder of the sacrificial face not including the notch, the thin portion, or the weakened portion and is configured for melting away during the thermal runaway event before a remaining plurality of faces of the metal cell can enclosure.

In some embodiments, the one of the plurality of faces being configured for failing includes a stable portion of the one of the plurality of faces and a sacrificial portion of the one of the plurality of faces. The sacrificial portion is configured for creating a vent in the one of the plurality of faces.

In some embodiments, the sacrificial portion is constructed with a first metal including a relatively low melting point. The stable portion is constructed with a second metal including a relatively high melting point.

In some embodiments, the sacrificial portion is constructed with a wall thickness thinner than a wall thickness of the stable portion.

In some embodiments, a notch including a thinned wall thickness is disposed around a perimeter of the sacrificial portion.

In some embodiments, the metal cell can enclosure is constructed with a clad metal.

In some embodiments, the battery cell further includes a layer of foam material configured for absorbing volumetric expansion of at least one of the electrodes.

In some embodiments, the layer of foam material includes a composite of foam and a metal hydroxide.

In some embodiments, the layer of foam material includes a metal hydroxide sheet which contains at least ninety parts of metal hydroxide per one hundred parts of the metal hydroxide sheet by weight.

In some embodiments, the battery further includes a layer of thermal interface material (TIM) adjacent to an interior surface of the metal cell can enclosure.

According to one alternative embodiment, a battery including a composite enclosure is provided. The battery includes a metal cell can enclosure including a plurality of faces. One of the plurality of faces is configured for locally failing during a thermal runaway event. The battery further includes a multilayer polymeric laminated film and a plurality of battery cells, each including a pair of electrodes including an anode and a cathode, a separator, and an electrolyte. The battery further includes a layer of foam material configured for absorbing volumetric expansion of at least one of the electrodes of each of the plurality of battery cells and a layer of thermal interface material adjacent to an interior surface of the metal cell can enclosure. The battery cell is hermetically sealed within the multilayer polymeric laminated film. The multilayer polymeric laminated film is hermetically sealed within the metal cell can enclosure.

In some embodiments, the one of the plurality of faces is constructed with a first metal with a relatively low melting point. A second of the plurality of faces is constructed with a second metal with a relatively high melting point.

In some embodiments, the one of the plurality of faces being configured for failing includes a stable portion of the one of the plurality of faces and a sacrificial portion of the one of the plurality of faces. The sacrificial portion is configured for creating a vent in the one of the plurality of faces.

According to one alternative embodiment, a battery including a composite enclosure is provided. The battery includes a metal cell can enclosure including a plurality of faces. One of the plurality of faces is configured for locally failing during a thermal runaway event. The battery further includes a plurality of multilayer polymeric laminated films and a plurality of battery cells, each including a pair of electrodes including an anode and a cathode, a separator, and an electrolyte. The battery further includes a layer of foam material configured for absorbing volumetric expansion of at least one of the electrodes of each of the plurality of battery cells and a layer of thermal interface material adjacent to an interior surface of the metal cell can enclosure. Each of the plurality of battery cells is hermetically sealed within one of the plurality of multilayer polymeric laminated films. The plurality of multilayer polymeric laminated films is hermetically sealed within the metal cell can enclosure.

In some embodiments, the one of the plurality of faces is constructed with a first metal with a relatively low melting point. A second of the plurality of faces is constructed with a second metal with a relatively high melting point.

The above features and advantages and other features and advantages of the present disclosure are readily apparent from the following detailed description of the best modes for carrying out the disclosure when taken in connection with the accompanying drawings.

### BRIEF DESCRIPTION OF DRAWINGS

FIG. 1 schematically illustrates in cross sectional view an exemplary battery including a plurality of battery cells, wherein each of the battery cells are enclosed within a laminated film and wherein the plurality of battery cells within the laminated film is contained within a metal cell can enclosure, in accordance with the present disclosure;

FIG. 2 schematically illustrates in cross sectional view an alternative exemplary battery including a plurality of battery cells, wherein the plurality of battery cells is enclosed within a laminated film and wherein the plurality of battery cells within the laminated film is contained within a metal cell can enclosure, in accordance with the present disclosure;

FIG. 3 schematically illustrates in perspective view an exemplary battery including a metal cell can enclosure including portions of the metal cell can enclosure constructed with diverse metals, in accordance with the present disclosure;

FIG. 4 schematically illustrates in front view an additional exemplary battery including a metal cell can enclosure including a first face of the battery including two battery terminals, in accordance with the present disclosure;

FIG. 5 schematically illustrates in front view the battery of FIG. 4, including a second face of the battery including a sacrificial portion configured for creating a vent in the second face, in accordance with the present disclosure;

FIG. 6A schematically illustrates in cross sectional view the second face of FIG. 5, including an aluminum portion welded to a steel portion of the metal cell can enclosure, on accordance with the present disclosure;

FIG. 6B schematically illustrates in cross sectional view an alternative embodiment of the second face of FIG. 5, including a thin steel section formed in a steel portion of the metal cell can enclosure, in accordance with the present disclosure;

FIG. 7 schematically illustrates an additional exemplary battery including a face including two battery terminals and a sacrificial portion, in accordance with the present disclosure;

FIG. 8 schematically illustrates an additional exemplary battery including a face including two battery terminals and a sacrificial portion, in accordance with the present disclosure;

FIG. 9 schematically illustrates an additional exemplary battery including a first face including two battery terminals, in accordance with the present disclosure;

FIG. 10 schematically illustrates the battery of FIG. 9 including a second face including a sacrificial portion, in accordance with the present disclosure;

FIG. 11 schematically illustrates an additional exemplary battery including a face including two battery terminals and a sacrificial portion, in accordance with the present disclosure; and

FIG. 12 schematically illustrates an additional exemplary battery including a face including two battery terminals and a sacrificial portion, in accordance with the present disclosure.

### DETAILED DESCRIPTION

A battery or battery system may include a plurality of battery cells. A battery cell may include an anode electrode, a cathode electrode, a separator, and an electrolyte.

A battery cell includes electrochemically reactive materials. The anode electrode includes anode active materials selected to electrochemically react with cathode active materials of the cathode electrode. Chemical reactions may happen between the electrode materials and electrolyte, or in the event of thermal runaway, gas will be generated.

A laminated aluminum pouch cell used in the art may not have a designated vent to control thermal runaway energy in gaseous form and may experience seal integrity failures due to the metallic aluminum layer. The metallic layer of the pouch material in configurations used in the art may be exposed to electrolyte due to heat sealing process variation and galvanic corrosion, followed by seal failure, or microcracks in an inner layer of a laminated aluminum pouch cell.

The disclosed battery includes a composite enclosure. The battery includes at least one lithium-ion battery cell, each battery cell including an anode and cathode pair. An enclosure is utilized around the battery cells to protect the battery cells and contain electrolyte within the battery. The enclosure includes a multilayer polymeric laminated film and a metal enclosure.

The disclosed battery solves the issues experienced by the laminate aluminum pouch cell used in the art by having a composite enclosure including a multilayer polymeric laminated film portion of the enclosure. The multilayer polymeric laminated film may not include a metallic layer as primary container of the lithium-ion battery cell. The multilayer polymeric laminated film may include materials selected from polyethylene terephthalate (PET), oriented nylon, and/or polypropylene (PP). The composite enclosure further includes metal cell can enclosure external to the multilayer polymeric laminated film. The metal cell can enclosure may be hermetically sealed. In one embodiment, the metallic enclosure which contains at least two lithium-ion battery cells there within and may include a hermetic or complete and airtight seal. The battery including the composite enclosure may provide a designated vent system including a two-stage vent.

A laminated aluminum pouch used in the art acting as a simple or single layer enclosure includes a layer of aluminum. The laminated aluminum pouch used in the art both contains the battery cell and corresponding electrolyte within the pouch and also provides a modicum of structural strength around the battery cell. The disclosed composite enclosure including the multilayer polymeric laminated film may serve the first purpose of the laminated aluminum pouch used in the art, containing the battery cell and the corresponding electrolyte within the laminated firm. The metal cell can enclosure of the composite enclosure may serve the second purpose of the laminated aluminum pouch used in the art, providing structural strength to the battery. Utilizing the multilayer polymeric laminated film without an aluminum layer may save cost and may remove potential for chemical reaction or electrochemical galvanic corrosion resulting from an electrolyte contacting an aluminum layer.

The disclosed composite enclosure may further include a two-stage vent gas flow control design by having dissimilar metals in the metal cell can enclosure. In a first stage, during a thermal runaway event, a notch, thin section, or other weakened portion of one of the faces of the metal cell can enclosure may quickly or initially fail, providing a relatively small vent. The first stage is configured to provide an initial aperture or vent through which hot gases may begin to exit the metal cell can enclosure. In a second stage, material the face including the vent created in the first stage may melt away, partially or wholly. This face configured for melting away may be described as a sacrificial face of the metal cell can enclosure. The notch, thin section, or weakened portion of the sacrificial face may be constructed with a material with a relatively low melting point, such as aluminum. The sacrificial face may similarly be constructed partially or wholly with a material with a relatively low melting point, such as aluminum. The sacrificial face may be configured to melt first when compared with other stable faces of the metal cell can enclosure, which may be constructed with materials with a relatively higher melting point, such as steel.

In one embodiment, the metal cell can enclosure may include a steel portion and an aluminum portion. Aluminum includes a lower melting temperature than steel. During a thermal runaway event, the temperature of the contents of the battery cell may exceed the melting temperature of the aluminum portion without exceeding the melting temperature of the steel portion. By selecting a configuration of the metal cell can enclosure and selecting where the aluminum portion is disposed and oriented in relation to the contained battery cell(s), hot gases escaping from the battery may channeled to exit through the aluminum portion and directed away from or protected from venting in the area of the battery including the steel portion.

In one embodiment, the metal cell can enclosure includes the steel portion including a top and a large flat surface by using steel which has a higher melting temperature than the exiting gas of battery cell in a thermal runaway situation. The steel portion provides for containment or controlled channeling of hot gases and protection of sensitive areas of the overall system. A side of the enclosure including electrical terminals for the battery or the terminal side of the metal cell can enclosure and/or an opposite side of the enclosure from the terminal side includes aluminum to provide ease of assembly. The terminal side of the metal cell can enclosure and/or opposite side of the enclosure may include a vent.

The disclosed battery may include a metallic enclosure design which contains a plurality of battery cells. Each battery cell may include least one cathode electrode, at least one anode electrode, and at least one separator sheet. Each battery cell is contained in a multilayer polymeric laminated film. Each battery cell includes an electrolyte also contained in the multilayer polymeric laminated film. In an alternative embodiment, a plurality of battery cells may be contained within a single multilayer polymeric laminated film.

In one embodiment, the multilayer polymeric laminated film material may include polymers. In another embodiment, the multilayer polymeric laminated film material may include polymers and a layer of metal, for example, aluminum, with a thickness of not more than 10 microns. With such a very thin layer of aluminum, the multilayer polymeric laminated film may be described as a multilayer polymeric aluminum laminated film. In another embodiment, the multilayer polymeric laminated film material may contact or include terminals of the battery.

The disclosed battery configuration provides efficient control of exiting gas direction and hot particle direction during a thermal runaway event. Aluminum is used to create a vent or guide venting gases. Steel is used to provide a barrier preventing the venting gases from venting in a particular direction.

The disclosed battery configuration provides excellent battery cell sealing integrity. By preventing a layer of metal in the film from coming into contact with the electrolyte, galvanic corrosion in the film serving as the primary polymeric enclosure of the battery cell is avoided. Further, a multilayer polymeric laminated film constructed with a polymer and without a layer of metal may be transparent or translucent, enabling inspection of separator integrity.

A shape and size of a vent in the metal cell can enclosure may be configured or created, for example, by disposing a particular material and/or geometry of material upon the metal cell can enclosure. For example, the metal cell can enclosure may include a relatively thick wall, with a vent portion of the wall including a relatively thin wall, such that the relatively thin wall melts away rapidly during a thermal runaway event, creating a vent in an intended location as controlled by the location and geometry of the vent portion of the wall. The metal cell can enclosure may include one or more faces or portions of a first metal, for example, steel, and one or more other faces or other portions of a second metal, for example, aluminum. In such an embodiment, the aluminum may melt or deteriorate during a thermal runaway event, creating a vent in the enclosure in a first direction, while the steel may prevent hot gases from venting in another direction.

In another embodiment, the metal cell can enclosure may include clad metal. Clad metal is a composite of two or more dissimilar metals, metallurgically bonded together, to achieve improved functional characteristics. The clad metal may provide excellent characteristics as compared to either a single metal or alloy. The bonding can be achieved by use of one of the various methods, including extruding the two metals, diffusion bonding, pressing or rolling sheets together under pressure. Other examples are envisioned. Clad metals allow combining of desirable characteristics and properties of individual metals and alloys into a material. The resulting component may exhibit excellent qualities such as improved corrosion resistance, lower porosity and better formability than the individual metals or alloys.

The metal cell can enclosure may be constructed with clad metal. Clad metal may enable a conventional laser seam welding process between dissimilar metals in the metal cell can enclosure, using aluminum as a sole material of enclosure.

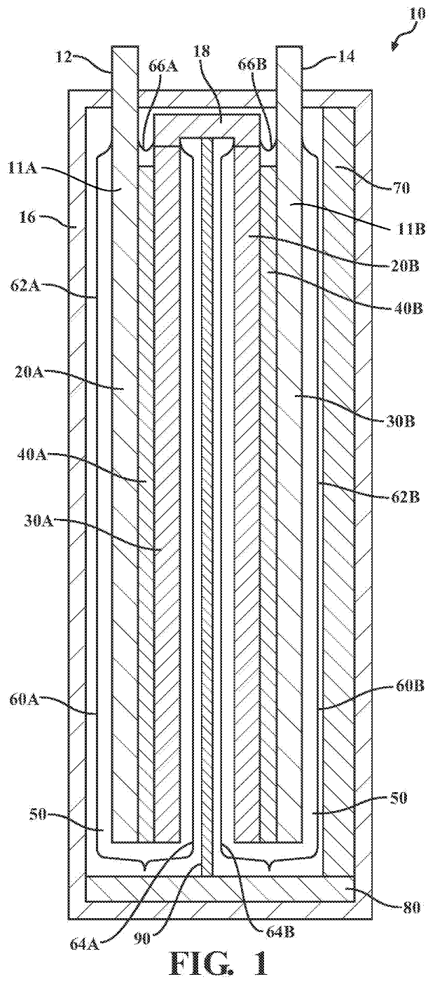

FIG. 1 schematically illustrates in cross sectional view an exemplary battery 10 including a plurality of battery cells 11A, 11B, wherein each of the battery cells 11A, 11B are enclosed within a respective multilayer polymeric laminated film 60A, 60B and wherein the plurality of battery cells 11A, 11B respectively within the multilayer polymeric laminated films 60A, 60B is contained within a metal cell can enclosure 16. The battery 10 includes a plurality of primary enclosures, the multilayer polymeric laminated films 60A, 60B, and a secondary enclosure, the metal cell can enclosure 16. The first battery cell 11A includes an anode 20A, a cathode 30A, and a separator 40A. The anode 20A includes an anode electrode and an anode current collector. The anode electrode includes an active material, a conductive material, and a binder, with these components dispersed within the anode electrode. The cathode 30A includes a cathode electrode and a cathode current collector. The cathode electrode includes an active material, a conductive material, and a binder, with these components dispersed within the anode electrode. The separator 40A enables ion transfer between the anode 20A and the cathode 30A while preventing physical contact between the anode 20A and the cathode 30A. An electrolyte 50 is provided within the multilayer polymeric laminated film 60A and provides for ion transfer between the anode 20A and the cathode 30A.

The multilayer polymeric multilayer polymeric laminated film 60A includes a first sidewall 62A, a second sidewall 64A, and a top portion 66A configured for enabling portions of the battery cell 11A to project out of the multilayer polymeric multilayer polymeric laminated film 60A while retaining a seal around the battery cell 11A. The multilayer polymeric multilayer polymeric laminated film 60A hermetically seals the battery cell 11A within the multilayer polymeric multilayer polymeric laminated film 60A. A first battery terminal 12 extends from the multilayer polymeric multilayer polymeric laminated film 60A and further from the metal cell can enclosure 16. The metal cell can enclosure 16 seals against the first battery terminal 12. The first battery terminal 12 extends from the anode 20A and provides a negative terminal for the battery 10.

The second battery cell 11B includes an anode 20B, a cathode 30B, and a separator 40B. The anode 20B includes an anode electrode and an anode current collector. The anode electrode includes an active material, a conductive material, and a binder, with these components dispersed within the anode electrode. The cathode 30B includes a cathode electrode and a cathode current collector. The cathode electrode includes an active material, a conductive material, and a binder, with these components dispersed within the anode electrode. The separator 40B enables ion transfer between the anode 20B and the cathode 30B while preventing physical contact between the anode 20B and the cathode 30B. An electrolyte 50 is provided within the multilayer polymeric laminated film 60B and provides for ion transfer between the anode 20B and the cathode 30B.

The multilayer polymeric multilayer polymeric laminated film 60B includes a first sidewall 62B, a second sidewall 64B, and a top portion 66B configured for enabling portions of the battery cell 11B to project out of the multilayer polymeric multilayer polymeric laminated film 60B while retaining a seal around the battery cell 11B. The multilayer polymeric multilayer polymeric laminated film 60B hermetically seals the battery cell 11B within the multilayer polymeric multilayer polymeric laminated film 60B. A second battery terminal 14 extends from the multilayer polymeric multilayer polymeric laminated film 60B and further from the metal cell can enclosure 16. The metal cell can enclosure 16 seals against the second battery terminal 14. The second battery terminal 14 extends from the cathode 30B and provides a positive terminal for the battery 10.

A conductive bridge 18 is illustrated electrically connecting the cathode 30A and the anode 20B, such that the first battery cell 11A and the second battery cell 11B are connected in series. Other configurations of battery cells are envisioned.

An exemplary foam panel 70 is illustrated disposed between the multilayer polymeric multilayer polymeric laminated film 60B and the metal cell can enclosure 16. The foam panel 70 or foam layer may include a composite of foam and a metal hydroxide. Foam may be utilized to absorb volume expansion of the battery cell, wherein the cell includes high expansion anode technology (e.g., lithium metal or lithium alloying components, silicon anode.) An alternative or additional foam panel may be disposed on an opposite side of the battery 10 between the multilayer polymeric multilayer polymeric laminated film 60A and the metal cell can enclosure 16. The foam panel 70 may include a metal hydroxide sheet which contains at least ninety parts of metal hydroxide per one hundred parts of the metal hydroxide sheet by weight.

An exemplary thermal interface material (TIM) panel 80 is illustrated. The TIM panel 80 is configured for enhancing heat transfer, for example, providing for heat transfer from the battery cells 11A, 11B to systems or an environment outside of the battery 10. Additionally, a heat transfer panel 90 is illustrated disposed between the multilayer polymeric multilayer polymeric laminated film 60A and the multilayer polymeric multilayer polymeric laminated film 60B. Heat transfer panel 90 is configured for receiving heat from the battery cells 11A, 11B and transferring the heat to the TIM panel 80.

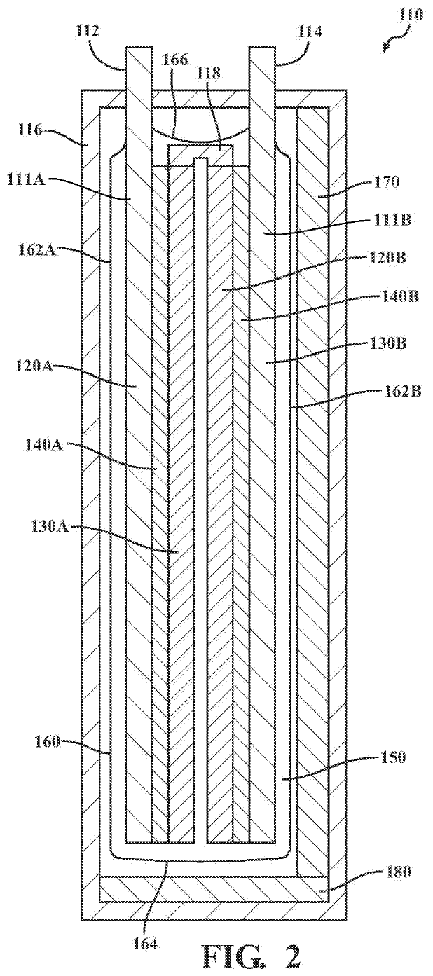

FIG. 1 illustrates the battery 10 including a plurality of battery cells 11A, 11B, each including a separate, respective multilayer polymeric multilayer polymeric laminated film 60A, 60B. In other embodiments, as is illustrated in FIG. 2, a multilayer polymeric multilayer polymeric laminated film 160 may include more than one battery cell 111A, 111B therewithin. FIG. 2 schematically illustrates in cross sectional view an alternative exemplary battery 110 including the plurality of battery cells 111A, 111B, wherein the plurality of battery cells 111A, 111B is enclosed within a multilayer polymeric laminated film 160 and wherein the plurality of battery cells 111A, 111B within the multilayer polymeric laminated film 160 is contained within a metal cell can enclosure 116. The battery 110 includes a plurality of primary enclosures, the multilayer polymeric laminated film 160, and a secondary enclosure, the metal cell can enclosure 116. The first battery cell 111A includes an anode 120A, a cathode 130A, and a separator 140A. The anode 120A includes an anode electrode and an anode current collector. The anode electrode includes an active material, a conductive material, and a binder, with these components dispersed within the anode electrode. The cathode 130A includes a cathode electrode and a cathode current collector. The cathode electrode includes an active material, a conductive material, and a binder, with these components dispersed within the anode electrode. The separator 140A enables ion transfer between the anode 120A and the cathode 130A while preventing physical contact between the anode 120A and the cathode 130A. An electrolyte 150 is provided within the multilayer polymeric laminated film 160 and provides for ion transfer between the anode 120A and the cathode 130A.

The second battery cell 111B includes an anode 120B, a cathode 130B, and a separator 140B. The anode 120B includes an anode electrode and an anode current collector. The anode electrode includes an active material, a conductive material, and a binder, with these components dispersed within the anode electrode. The cathode 130B includes a cathode electrode and a cathode current collector. The cathode electrode includes an active material, a conductive material, and a binder, with these components dispersed within the anode electrode. The separator 140B enables ion transfer between the anode 120B and the cathode 130B while preventing physical contact between the anode 120B and the cathode 130B. The electrolyte 150 is provided within the multilayer polymeric laminated film 160 and provides for ion transfer between the anode 120B and the cathode 130B.

The electrodes of the first battery cell 111A and the electrodes of the second battery cell 111B are prevented from ion exchange with each other. An optional barrier may be placed between the cathode 130A and the anode 120B. One or both of the anode 120B and the cathode 130A may include a current collector plate that is sealed around a perimeter with the multilayer polymeric laminated film 160 such that a liquid electrolyte 150 of the first battery cell 111A and a liquid electrolyte 150 of the second battery cell 111B do not mix.

The multilayer polymeric laminated film 160 includes a first sidewall 162A, a second sidewall 162B, a bottom portion 164, and a top portion 166 configured for enabling portions of the battery cells 111A, 111B to project out of the multilayer polymeric laminated film 160 while retaining a seal around the battery cells 111A, 111B. The multilayer polymeric laminated film 160 hermetically seals the battery cells 111A, 111B within the multilayer polymeric laminated film 160. A first battery terminal 112 extends from the multilayer polymeric laminated film 160 and further from the metal cell can enclosure 116. The metal cell can enclosure 116 seals against the first battery terminal 112. The first battery terminal 112 extends from the anode 120A and provides a negative terminal for the battery 110.

A second battery terminal 114 extends from the multilayer polymeric laminated film 160 and further from the metal cell can enclosure 116. The metal cell can enclosure 116 seals against the second battery terminal 114. The second battery terminal 114 extends from the cathode 130B and provides a positive terminal for the battery 110.

A conductive bridge 118 is illustrated electrically connecting the cathode 130A and the anode 120B, such that the first battery cell 111A and the second battery cell 111B are connected in series. Other configurations of battery cells are envisioned.

An exemplary foam panel 170 is illustrated disposed between the multilayer polymeric laminated film 160 and the metal cell can enclosure 116. The foam panel 170 may include a composite of foam and a metal hydroxide. An alternative or additional foam panel may be disposed on an opposite side of the battery 110 between the multilayer polymeric laminated film 160 and the metal cell can enclosure 116.

An exemplary thermal interface material (TIM) panel 180 is illustrated. The TIM panel 180 is configured for enhancing heat transfer, for example, providing for heat transfer from the battery cells 111A, 111B to systems or an environment outside of the battery 110.

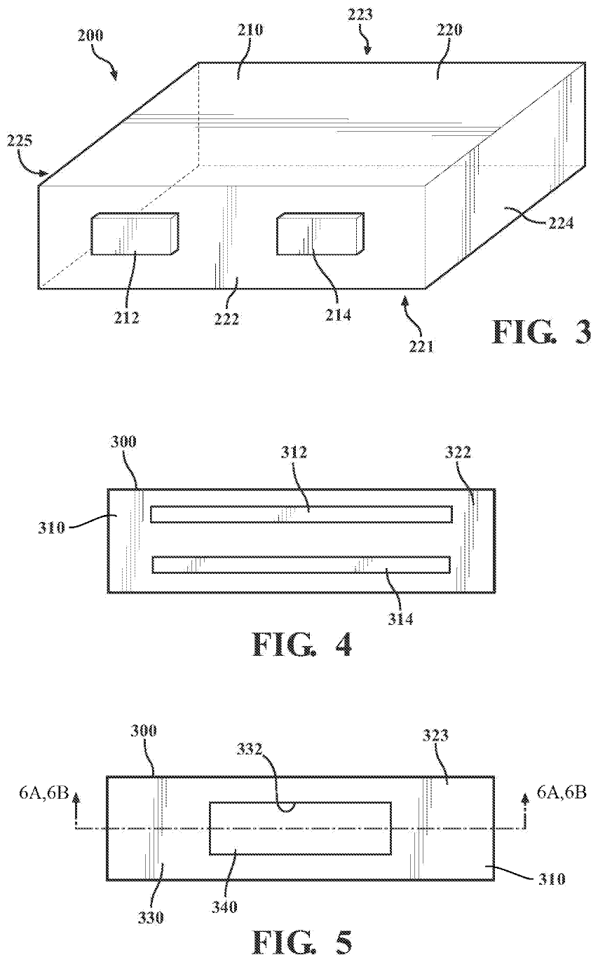

FIG. 3 schematically illustrates in perspective view an exemplary battery 200 including a metal cell can enclosure 210 including portions of the metal cell can enclosure 210 constructed with diverse metals. The metal cell can enclosure 210 may be constructed with various shapes. In the embodiment of FIG. 3, the metal cell can enclosure 210 includes a rectangular cuboid shape, with six sides, including a front side 222, a rear side 223, a top side 220, a bottom side 221, a left side 225, and a right side 224. In some embodiments, the particular side of a battery may be arbitrary, with the battery 200 being disposed in a neutral or ambiguous environment. In other embodiments, faces 220, 221, 222, 223, 224, and 225 of the battery 200 may face sensitive equipment or objects. A person may be situated close to one of the faces 220, 221, 222, 223, 224, and 225 of the battery 200. During a thermal runaway event, hot gases may be generated within the battery 200, and controlled release of those hot gases may be desirable. Different materials have different tolerances of high temperatures. For example, steel and steel alloys have higher melting points than aluminum and aluminum alloys. Gas temperatures within battery 200 may exceed the melting point of aluminum while remaining below the melting point of steel. In other embodiments, the gas temperatures within the battery 200, as they rise from normal operating temperatures to the temperatures experienced during a thermal runaway event, will exceed a maximum temperature of a first material with a relatively lower maximum temperature before the gas temperatures exceed a maximum temperature of a second material with a relatively higher maximum temperature. The metal cell case enclosure 210 may include diverse materials or diverse metals, with the diverse metals enabling a controlled release of hot gases from the battery 200 during a thermal runaway event. For example, the face 222 may be constructed with aluminum or an aluminum alloy, while the faces 220, 221, 223, 224, and 225 may be constructed with steel or a steel alloy. The battery 200 may be disposed and oriented in a system such that the face 222 may be pointed in a direction where hot gases being expelled from the battery 200 in the direction of the face 222 may do little or no harm, while sensitive or valuable objects may be disposed in the direction of the face 223 opposite of the face 222. Any of the faces 220, 221, 222, 223, 224, and 225 may be configured with either a relatively low temperature resistant material or a relatively high temperature resistant material, depending upon which direction hot gases may be expelled without adverse effects.

FIGS. 4 and 5 illustrate a battery 300 including a sacrificial portion 340 in one of the faces 322, 323 of the battery 300. FIG. 4 schematically illustrates in front view battery 400 including a metal cell can enclosure 310 including a first face of the battery including two battery terminals 312, 314. The face 222 may include a high temperature resistant material such as steel, such that hot gases that are experienced within the battery 300 during a thermal runaway event may be expelled in a different direction that the direction of face 222. In one example, delicate electronic equipment may be close to or abutting the face 222, such that hot gases being expelled in the area of the face 222 may be undesirable.

FIG. 5 schematically illustrates in front view the battery 300 of FIG. 4, including a second face 323 of the battery including a sacrificial portion 340 configured for creating a vent in the second face 323. The face 232 includes a stable portion 330, which may include a material with a relatively higher temperature resistance than the sacrificial portion 340. This relatively higher temperature resistance may be achieved through thicker material, material with a higher melting point, a high temperature resistant coating such as a layer of thermal insulation, or by other means. The sacrificial portion 340, having a relatively lower temperature resistance than the stable portion 330, will melt, break away, or otherwise locally fail, such that a vent may be created by the sacrificial portion 340. The vent may be a through-hole in the face 323 defined by an inner perimeter 332 of the stable portion 330 that remains after the sacrificial portion 340 locally fails. A sectional view 6A/6B is defined in FIG. 5.

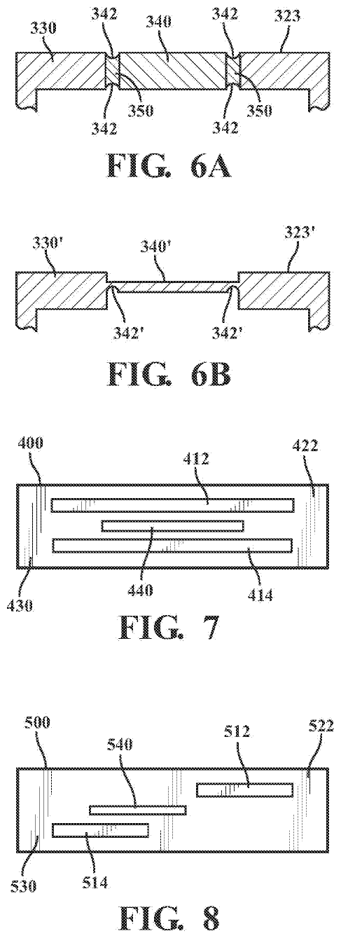

FIG. 6A schematically illustrates in cross sectional view 6A, as defined in FIG. 5, the second face of FIG. 5, including an aluminum portion welded to a steel portion of the metal cell can enclosure. The face 323 is illustrated including the stable portion 330 and the sacrificial portion 340. In the embodiment of FIG. 6A, the stable portion 330 may be constructed with steel and the sacrificial portion 340 may be constructed with aluminum. The sacrificial portion 340 may be welded into place, with weld joints 350 resulting from the welding process. The weld joints 350 may be configured to be thinner than the material of the stable portion 330 and the sacrificial portion 340, thereby creating notches 342 in the face 323. The notches 342 are formed, thereby creating thinner wall sections on face 323. The notches 342 make local failure of the face 323 at or near the notches increasingly likely during a thermal runaway event. As a result, the sacrificial portion 340 may break away or otherwise locally fail during a thermal runaway event, thereby creating a vent in the face 323.

FIG. 6B schematically illustrates in cross sectional view an alternative embodiment of the second face 323 of FIG. 5, including a sacrificial portion 340′ embodied as a thin steel section formed in the face 323′ of the metal cell can enclosure 310 of FIG. 5. The face 323′ includes a stable portion 330′ and the sacrificial portion 340′. Around a perimeter of the sacrificial portion 340′, a notch 342′ is formed in the face 323′. During a thermal runaway event, the thinner material of the sacrificial portion 340′ and the thin section caused by the notch 342′ makes the sacrificial portion 340′ like to break away or otherwise locally fail during the thermal runaway event, thereby creating a vent in the face 323′.

FIG. 7 schematically illustrates an additional exemplary battery 400 including a face 422 including two battery terminals 412, 414 and a sacrificial portion 440. The face 422 includes a stable portion 430 and the sacrificial portion 440. The sacrificial portion 440 may include relatively thinner walls than the stable portion 430, may be constructed with a material with a relatively lower melting point than the stable portion 430, or may otherwise be configured to locally fail during a thermal runaway event, such that a vent is created upon face 422 at the location of the sacrificial portion 440.

FIG. 8 schematically illustrates an additional exemplary battery 500 including a face 522 including two battery terminals 512, 514 and a sacrificial portion 540. The face 522 includes a stable portion 530 and the sacrificial portion 540. The sacrificial portion 540 may include relatively thinner walls than the stable portion 530, may be constructed with a material with a relatively lower melting point than the stable portion 530, or may otherwise be configured to locally fail during a thermal runaway event, such that a vent is created upon face 522 at the location of the sacrificial portion 540.

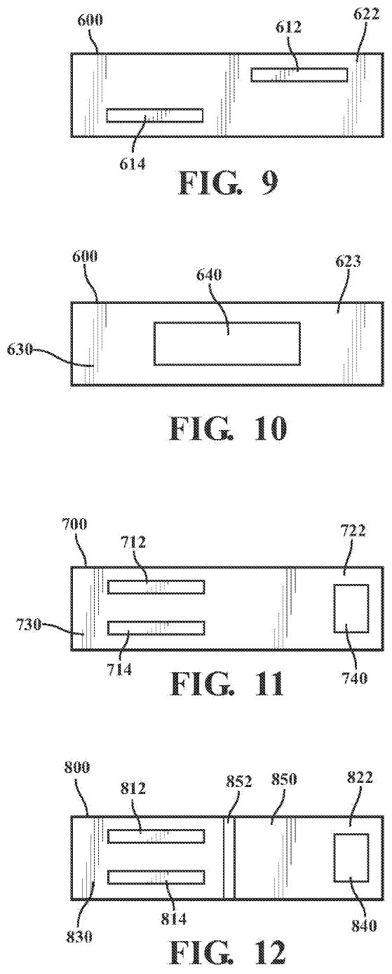

FIGS. 9 and 10 illustrate a battery 600 including a first face 622 and a second face 623. FIG. 9 schematically illustrates the battery 600 including the first face 622 including two battery terminals 612, 614. FIG. 10 schematically illustrates the battery 600 of FIG. 9 including the second face 623 including a stable portion 630 and a sacrificial portion 640. The sacrificial portion 640 may include relatively thinner walls than the stable portion 630, may be constructed with a material with a relatively lower melting point than the stable portion 630, or may otherwise be configured to locally fail during a thermal runaway event, such that a vent is created upon face 622 at the location of the sacrificial portion 640.

FIG. 11 schematically illustrates an additional exemplary battery 700 including a face 722 including two battery terminals 712, 714, a stable portion 730, and a sacrificial portion 740. The sacrificial portion 740 may include relatively thinner walls than the stable portion 730, may be constructed with a material with a relatively lower melting point than the stable portion 730, or may otherwise be configured to locally fail during a thermal runaway event, such that a vent is created upon face 722 at the location of the sacrificial portion 740.

FIG. 12 schematically illustrates an additional exemplary battery 800 including a face 822 including two battery terminals 812, 814, a first stable portion 830, a second stable portion 850, and a sacrificial portion 840. The sacrificial portion 840 may include relatively thinner walls than the stable portion 830, may be constructed with a material with a relatively lower melting point than the stable portion 830, or may otherwise be configured to locally fail during a thermal runaway event, such that a vent is created upon face 822 at the location of the sacrificial portion 840. The face 822 further includes a notch 852 spanning across the face 822 between the first stable portion 830 and the second stable portion 850. The notch 852 may enable one of first stable portion 830 and the second stable portion 850 to break away, depending upon the specific conditions of the thermal runaway event.

While the best modes for carrying out the disclosure have been described in detail, those familiar with the art to which this disclosure relates will recognize various alternative designs and embodiments for practicing the disclosure within the scope of the appended claims.

What is claimed is:

1. A battery including a composite enclosure, comprising:
a metal cell can enclosure including a plurality of faces, wherein one of the plurality of faces is configured for locally failing during a thermal runaway event;
a multilayer polymeric laminated film; and
a battery cell including a pair of electrodes including an anode and a cathode, a separator, and an electrolyte;
wherein the battery cell is hermetically sealed within the multilayer polymeric laminated film; and
wherein the multilayer polymeric laminated film is contained within the metal cell can enclosure.

2. The battery of claim 1, further comprising a plurality of battery cells.

3. The battery of claim 2, further comprising a plurality of multilayer polymeric laminated films;
wherein each of the plurality of battery cells is hermetically sealed within one of the plurality of multilayer polymeric laminated films; and
wherein the plurality of multilayer polymeric laminated films is hermetically sealed within the metal cell can enclosure.

4. The battery of claim 1, wherein the plurality of battery cells is sealed within the multilayer polymeric laminated film.

5. The battery of claim 1, wherein the one of the plurality of faces is constructed with a first metal with a relatively low melting point; and
wherein a second of the plurality of faces is constructed with a second metal with a relatively high melting point.

6. The battery of claim 1, wherein the metal cell can enclosure including a plurality of faces, wherein one of the plurality of faces is configured as a sacrificial face including a two-stage vent, including:
a first stage including a notch, a thin portion, or a weakened portion configured for initially failing at an outset of a thermal runaway event; and
a second stage including a remainder of the sacrificial face not including the notch, the thin portion, or the weakened portion and configured for melting away during the thermal runaway event before a remaining plurality of faces of the metal cell can enclosure.

7. The battery of claim 1, wherein the one of the plurality of faces being configured for failing includes a stable portion of the one of the plurality of faces and a sacrificial portion of the one of the plurality of faces, the sacrificial portion being configured for creating a vent in the one of the plurality of faces.

8. The battery of claim 7, wherein the sacrificial portion is constructed with a first metal including a relatively low melting point; and
wherein the stable portion is constructed with a second metal including a relatively high melting point.

9. The battery of claim 7, wherein the sacrificial portion is constructed with a wall thickness thinner than a wall thickness of the stable portion.

10. The battery of claim 7, wherein a notch including a thinned wall thickness disposed around a perimeter of the sacrificial portion.

11. The battery of claim 1, wherein the metal cell can enclosure is constructed with a clad metal.

12. The battery of claim 1, wherein the battery cell further includes a layer of foam material configured for absorbing volumetric expansion of at least one of the electrodes.

13. The battery of claim 12, wherein the layer of foam material includes a composite of foam and a metal hydroxide.

14. The battery of claim 12, wherein the layer of foam material includes a metal hydroxide sheet which contains at least ninety parts of metal hydroxide per one hundred parts of the metal hydroxide sheet by weight.

15. The battery of claim 1, further comprising a layer of thermal interface material (TIM) adjacent to an interior surface of the metal cell can enclosure.

16. A battery including a composite enclosure, comprising:
a metal cell can enclosure including a plurality of faces, wherein one of the plurality of faces is configured for locally failing during a thermal runaway event;
a multilayer polymeric laminated film;
a plurality of battery cells, each including a pair of electrodes including an anode and a cathode, a separator, and an electrolyte;
a layer of foam material configured for absorbing volumetric expansion of at least one of the electrodes of each of the plurality of battery cells; and
a layer of thermal interface material adjacent to an interior surface of the metal cell can enclosure; and
wherein the battery cell is hermetically sealed within the multilayer polymeric laminated film; and
wherein the multilayer polymeric laminated film is hermetically sealed within the metal cell can enclosure.

17. The battery of claim 16, wherein the one of the plurality of faces is constructed with a first metal with a relatively low melting point; and
wherein a second of the plurality of faces is constructed with a second metal with a relatively high melting point.

18. The battery of claim 16, wherein the one of the plurality of faces being configured for failing includes a stable portion of the one of the plurality of faces and a sacrificial portion of the one of the plurality of faces, the sacrificial portion being configured for creating a vent in the one of the plurality of faces.

19. A battery including a composite enclosure, comprising:
a metal cell can enclosure including a plurality of faces, wherein one of the plurality of faces is configured for locally failing during a thermal runaway event;
a plurality of multilayer polymeric laminated films;
a plurality of battery cells, each including a pair of electrodes including an anode and a cathode, a separator, and an electrolyte;
a layer of foam material configured for absorbing volumetric expansion of at least one of the electrodes of each of the plurality of battery cells; and
a layer of thermal interface material adjacent to an interior surface of the metal cell can enclosure; and
wherein each of the plurality of battery cells is hermetically sealed within one of the plurality of multilayer polymeric laminated films; and
wherein the plurality of multilayer polymeric laminated films is hermetically sealed within the metal cell can enclosure.

20. The battery of claim 19, wherein the one of the plurality of faces is constructed with a first metal with a relatively low melting point; and
wherein a second of the plurality of faces is constructed with a second metal with a relatively high melting point.
